(19) United States
(12) Patent Application Publication
(10) Pub. No.: US 2014/0327363 A1
(43) Pub. Date: Nov. 6, 2014

(54) MENIAL POWER CONSUMPTION LIGHT EMITTING DIODE (LED) LAMP DEVICE

(71) Applicants: Mostafa Tehrani Nejad, Behshahr (IR); Ali Rangi, Arak (IR); Roohollah Karami, Mahshahr Port (IR)

(72) Inventors: Mostafa Tehrani Nejad, Behshahr (IR); Ali Rangi, Arak (IR); Roohollah Karami, Mahshahr Port (IR)

(21) Appl. No.: 14/336,923

(22) Filed: Jul. 21, 2014

(51) Int. Cl. H05B 33/08

(52) U.S. Cl. CPC H05B 33/0854; H05B 33/0815
USPC 315/152

(57) ABSTRACT

The various embodiments herein provide a very low or menial power consumption LED lamp with a radiance angle of 360 degrees. The LED lamp requires less time for exhibiting maximum radiance. The LED lamp has a long life of operation and is physically safe to use. The LED lamp an additional feature to automatically adjust the optical flux of the LED depending on the luminance of the surrounding environment. The LED lamp comprises a power supply module to supply a DC voltage to the entire circuit, a driver module for adjusting the current level supplied to LEDs depending on the luminance of the surrounding environment, a multi-vibrator and flip-flop module adopted to flash the LED with a period of one second and a LED Surface Mount Device (SMD) assembly.

### TECHNICAL FIELD

The embodiments herein are generally related to low power consumption lamps and particularly to low power consumption Light Emitting Diode (LED) lamps. The embodiments herein are more particularly related to very low power consumption or menial power consumption LED lamps.

### DESCRIPTION OF THE RELATED ART

The Light-emitting diodes (LEDs) are semiconductor devices that convert electricity to light. LED lighting is also called “solid state lighting” because the light is emitted from a solid object a block of semiconductor material rather than from a vacuum or gas tube, as in traditional incandescent or fluorescent lights. The LED technology for general purpose lighting is rapidly growing, with significant potential for energy savings. LED devices perform exceptionally well in normal conditions, proving up to 10 times more efficient than incandescent lights. The LED lighting products are now available are three to four times more energy efficient than incandescent bulbs and last up to five times longer than compact fluorescents, so far the longest-lasting lighting alternative.

Even though LED lamps are considered best in terms of power consumption, but they have some drawbacks due to their design. One of the drawbacks with LED lamps is that the radiance angle of LED lamp is about 120 degrees and hence these LED lamps are used in flashlights and showcases. But the radiance angle should be more than 180 degrees in ordinary everyday usage lamps used for illuminating the entire surroundings/environment. Otherwise some portions or areas of the surroundings are left in dark. Furthermore the LED lamps are the most expensive among other lamps.

In the view of foregoing, there is a need for a cost efficient, very low power consumption or menial power consumption LED lamp with maximum radiance angle and is. Further there is a need for a menial power consumption LED lamp with a higher longevity. Still further there is a need for a menial power consumption LED lamp which is physically safe for daily use.

The above mentioned shortcomings, disadvantages and problems are addressed herein and which will be understood by reading and studying the following specification.

### OBJECTS OF THE EMBODIMENTS

The primary object of the embodiments herein is to provide a very low power consumption or menial power consumption LED lamp which has maximum luminance angle.

Another object of the embodiments herein is to provide a very low power consumption or menial power consumption LED lamp which requires less time for exhibiting maximum radiance.

Yet another object of the embodiments herein is to provide a very low power consumption or menial power consumption LED lamp which has long life of operation and is physically safe to use.

Yet another embodiment of the present invention is to design a very low power consumption or menial power consumption LED lamp which is less expensive due to its design.

Yet another embodiment of the present invention is to auto adjust the optical flux of the very low power consumption or menial power consumption LED lamp depending on the luminance of the surrounding environment.

### SUMMARY

The various embodiments herein provide a very low or menial power consumption LED lamp which has a radiance angle of 360 degrees. The very low or menial power consumption LED lamp of the embodiments herein requires less time for exhibiting maximum radiance or lumens. The very low or menial power consumption LED lamp has a long life of operation and is physically safe to use. Further the very low or menial power consumption LED lamp of the embodiments herein has an additional feature to automatically adjust an optical flux of the LED depending on the luminance of the surrounding environment. According to one embodiment herein, the very low or menial power consumption Light Emitting Diode (LED) lamp system comprises a power supply module configured to supply a direct current (DC) voltage to the entire circuit, a driver module configured to adjust the current level supplied to LEDs depending on the luminance of the surrounding environment, a multivibrator and flip-flop module adopted to flash the LED with a typical period of one second and a LED Surface Mount Device (SMD) assembly.

According to an embodiment herein, the driver module comprises a DC-DC controller which is configured to increases a frequency of an input voltage to a predefined value, a MOSFET transistor which is configured to improve the overall efficiency of the DC/DC converter by increasing a current coefficient of the input received, and an opto-coupler comprising a light absorbing diode configured to change an internal impedance depending on the luminance of surrounding environment.

According to an embodiment herein, the opto-coupler adjusts a current flowing to the LED-SMD assembly depending on the environment light.

According to an embodiment herein, the multi-vibrator and flip-flop module comprises a multi-vibrator which is configured to generate a square wave signal depending on the voltage received from the driver module and a flip-flop circuit which is configured to switch the LEDs on/off depending on the square wave signal received from the multi-vibrator, and wherein the square wave generated has 50% duty cycle.

According to an embodiment herein, the flip-flop circuit further comprises at least two diodes which are positioned in reverse manner, at least two resistors which are connected in series with the diodes, and at least two FET transistors which are configured to conduct individually for a predetermined interval of time and wherein one of the two transistors is a P-FET and another transistor is a N-FET.

According to an embodiment herein, the square wave signal generated by the multi-vibrator is adopted to operate the two FET transistors individually by applying a positive voltage of square wave signal to the P-FET transistor and a negative voltage of square wave signal to the N-FET transistor.

According to an embodiment herein, the LED-SMD board is divided into at least two parts and wherein the two parts never work simultaneously.

According to an embodiment herein, the two parts of LED-SMD board are driven by the voltage received from the transistors of the flip-flop circuit, and wherein only one part of the SMD board is operated on for a preset time period.

According to an embodiment herein, the LED-SMD assembly is arranged in such a way that the phase difference between the two parts of the SMD board is 180 degrees.

According to an embodiment herein, the output luminance of the LED lamp depends on the change in a beam angle, special setting of SMDs, and also the size of the light bulb.

These and other objects and advantages of the present invention will become readily apparent from the following detailed description taken in conjunction with the accompanying drawings.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a perspective view of a menial power consumption LED lamp device, according to an embodiment herein.

FIG. 2 illustrates an exploded perspective view of the menial power consumption LED lamp device indicating the order of assembly of various parts, according to an embodiment herein.

FIG. 3 illustrates a functional block circuit diagram for drive module of the menial power consumption LED lamp device, according to an embodiment herein.

FIG. 4 illustrates a functional block circuit diagram of multi-vibrator module adopted in the menial power consumption LED lamp device, according to an embodiment herein.

FIG. 5 illustrates a functional block circuit diagram of flip-flop module used in the menial power consumption LED lamp device, according to an embodiment herein.

FIG. 6 illustrates a block diagram of an arrangement of the LEDs in the SMD assembly, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a very low or menial power consumption LED lamp which has a radiance angle of 360 degrees. The very low or menial power consumption LED lamp of the embodiments herein requires less time for exhibiting maximum radiance or lumens. The very low or menial power consumption LED lamp has a long life of operation and is physically safe to use. Further the very low or menial power consumption LED lamp of the embodiments herein has an additional feature to automatically adjust an optical flux of the LED depending on the luminance of the surrounding environment. According to one embodiment herein, the very low or menial power consumption Light Emitting Diode (LED) lamp system comprises a power supply module configured to supply a direct current (DC) voltage to the entire circuit, a driver module configured to adjust the current level supplied to LEDs depending on the luminance of the surrounding environment, a multi-vibrator and flip-flop module adopted to flash the LED with a typical period of one second and a LED Surface Mount Device (SMD) assembly.

According to an embodiment herein, the driver module comprises a DC-DC controller which is configured to increases a frequency of an input voltage to a predefined value, a MOSFET transistor which is configured to improve the overall efficiency of the DC/DC converter by increasing a current coefficient of the input received, and an opto-coupler comprising a light absorbing diode configured to change an internal impedance depending on the luminance of surrounding environment.

According to an embodiment herein, the opto-coupler adjusts a current flowing to the LED-SMD assembly depending on the environment light.

According to an embodiment herein, the multi-vibrator and flip-flop module comprises a multi-vibrator which is configured to generate a square wave signal depending on the voltage received from the driver module and a flip-flop circuit which is configured to switch the LEDs on/off depending on the square wave signal received from the multi-vibrator, and wherein the square wave generated has 50% duty cycle.

According to an embodiment herein, the flip-flop circuit further comprises at least two diodes which are positioned in reverse manner, at least two resistors which are connected in series with the diodes, and at least two FET transistors which are configured to conduct individually for a predetermined interval of time and wherein one of the two transistors is a P-FET and another transistor is a N-FET.

According to an embodiment herein, the square wave signal generated by the multi-vibrator is adopted to operate the two FET transistors individually by applying a positive voltage of square wave signal to the P-FET transistor and a negative voltage of square wave signal to the N-FET transistor.

According to an embodiment herein, the LED-SMD board is divided into at least two parts and wherein the two parts never work simultaneously.

According to an embodiment herein, the two parts of LED-SMD board are driven by the voltage received from the transistors of the flip-flop circuit, and wherein only one part of the SMD board is operated on for a preset time period.

According to an embodiment herein, the LED-SMD assembly is arranged in such a way that the phase difference between the two parts of the SMD board is 180 degrees.

According to an embodiment herein, the output luminance of the LED lamp depends on the change in a beam angle, special setting of SMDs, and also the size of the light bulb.

When AC power of 50 Hz or 60 Hz with 220v voltage reaches the lamp circuit, the circuit is run or operated in the first half cycle of AC power. Because the alternative voltage has a high potential difference, this voltage is to be limited and then converted to DC to operate with 30 KHz frequency. In order to supply power to switch mode power supply unit, AC power voltage is to be adjusted at least 1/15 of the input power voltage which is considered in one embodiment herein as 15v. As a result, the multi vibrator circuit gets ready to support the transformer and then the differential of the transformer which is AC power is transformed into DC to operate the circuits due to the capacitor C1(400v-10 μf) that limits the voltage through four Schottky diodes (B250C1500) that rectify the voltage.

Also, the voltage is rectified by means of a Zener diode and is stabilized by an electrolytic capacitor (bipolar) to provide the IC voltage (Max668). Then, the differential voltage of this IC biases with 30 KHz frequency of an SMD that resembles an octo coupler IC. This element is an exclusive FDS (FDS6680), which is nothing but Single N-Channel Logic Level PWM Optimized Power Trench MOSFET.

In this case, a low impedance voltage is created at the two heads of transformer. After that, the voltage is changed into low impedance via inductance. Then the voltage reaches 15v with the current of MAX: 500 mA to support the circuit and LEDs by cutting the inductive loops. A hysteresis is left in initial and secondary SMD transformers due to high frequency of 30 KHz. This distortion is removed by an electrolytic capacitor and a Scottky diode in the secondary differential voltage. Moreover, the voltage becomes direct via this diode and it is rectified, stabilized by removing distortions and fixed by two other electrolytic capacitors. So this stabilized, rectified and distortion free voltages 15v reaches the IC timer of TCL type, which is fast, and biases through multi-vibrator with an output frequency (100 Hz) in Schmitt trigger. It is very effective to operate the MOSFET transistors such as P-MOSFET, P-FET, N-MOSFET, and N-FET. Afterwards, the differential voltage of this IC enters the gate of a multi-vibrator module (Flip Flop circuit) to have two opposite differential voltages. Also, a hysteresis feedback makes the Flip Flop circuit ready to have two separate differential voltages. In this case, when we have Flip Flop (+) in N-FET transistor, the transistor switches and allows the Drain to flow in different parts and lighten half of the LEDs on the board. On the other hand, when the same differential voltage is with 0(zero) voltage, in 10 ms (time), the transistor P-FET switches and the other half of LEDs will be lit up and N-FET transistor turns off. Exactly after 10 ms, this operation is reversed and it continues as long as the AC power is connected to the lamp. At this moment, both the series of LEDs on five sides in 90° distance from each other lit up. The SMD=LEDs used in this invention are twice efficiency and powerful as much as the other lamps to prove that it lightens twice as much as other lamps. Usually, there are 2 rows of SMDs including 5 series and 4 parallel plus 2 on the corners that is 22 SMDs totally. Doubling this number equals 44 SMDs that are used in this lamp but current consumption shows 22 SMDs. In order to prevent any problem regarding the frequent on/off of the SMDs, 2 countering Scottky diodes via a flat capacitor are biased. The common diode of 1 n series can't be used in this circuit because it sinks and is burnt.

At the end of the circuit, two electrolytic capacitors are connected in parallel by SMDs and Shunt resistor to save the current in time of high voltage and to keep the SMDs lit up in time of 10 ms blackout. They also support the ripple, delay the zero crossing and remove the fluctuations of SMD light in the circuit. It is clear that SMDs light changes in harmony with current and does not change with the voltage change. As a result, SMDs illuminate with more light flux and more consistent light.

Owing to low power loss and sorting of SMDs and the use of SMD of 5050-A22 and ¼ w, this lamp does not need cooler. Also, the transistors do not need cooler due to instantaneous current and the type of FET transistor with 20 A. A varistor is designed in the lamp so that its internal resistance changes due to the environment light and these changes are transferred to bias gate via voltage to control the current flow between Drain and Source. Also, when the environment light is not enough, it provides the highest current and when the environment light is sufficient, it provides the lowest current for FET transistors. So, this opto-coupler does not have any tolerance for the whole circuit.

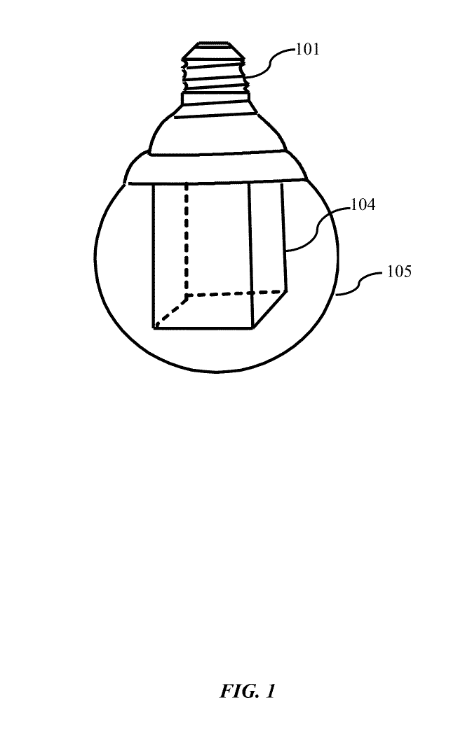

The various embodiments herein provide a low power consuming LED lamp which has a radiance angle of 360 degrees. FIG. 1 illustrates a perspective view of the very low or menial power consumption LED lamp, according to an embodiment of the present disclosure. The LED lamp disclosed in the embodiments herein requires less time for exhibiting maximum radiance. The LED lamp has a long life of operation and is physically safe to use. Further the LED lamp an additional feature to automatically adjust the optical flux of the LED depending on the luminance of the surrounding environment. With respect to FIG. 1, the LED lamp has a lamp head with screw arrangement 101 for fitting LED lamp into a lamp holder or receptacle. A LED-SMD assembly is housed and fixed inside the LED housing or lamp main body 105. This lamp housing is a glass body 105.

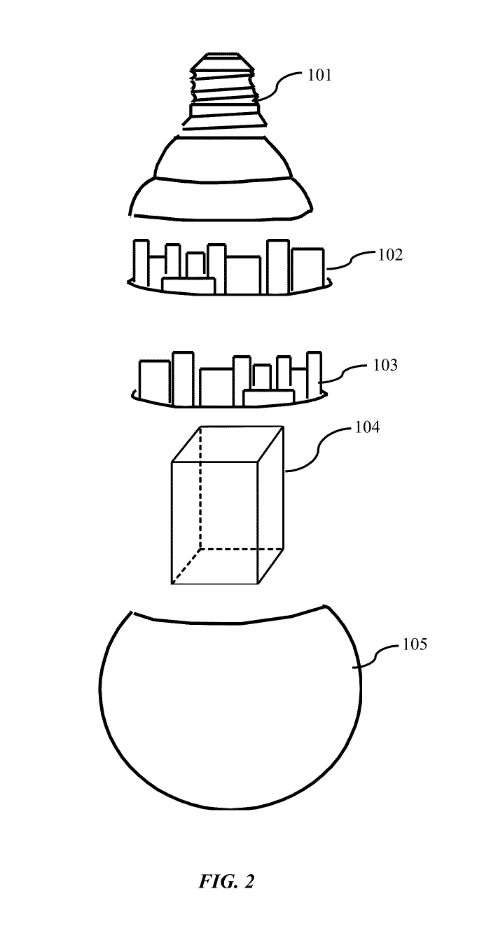

FIG. 2 illustrates an exploded perspective view of the LED lamp indicating the order of assembly of the various components of the LED lamp in a LED lamp device, according to an embodiment herein. The LED lamp comprises a power supply module, a driver module 102, a multi-vibrator and flip-flops circuit module 103, a—SMD assembly 104 and a radiance angle amplifier. The LED lamp receives an AC voltage of 230V with 50-60 Hz frequency at a holder 101 of the lamp. The high AC voltage is limited and converted to 15V DC voltage with 30 kHz frequency. The LED lamp uses a switch mode power supply to down-convert and regulates the AC voltage to 15V DC voltage. The power supply module residing inside the holder 101 supplies the DC voltage to the driver module, which is configured to provide constant current source for optimized control of LED SMDs. The main function of driver module 102 is to offer current adjustments for operating the LEDs according to the luminance/brightness surrounding the lamp. Depending on the surrounding luminance, the voltage of 15V and the variable current (max. of 350 mA) are used to trigger the SMD assembly and the entire circuit. The multi-vibrator and flip-flop module 103 is configured to generate square wave pulses, which are provided to LED SMD boards 104. The generated pulses light the plurality of LEDs of SMD assembly 104 at an interval of 100 ps. The LED SMD assembly 104 resides inside a glass bulb 105 of the LED lamp.

According to an embodiment herein, when AC power of 230V/50-60 Hz is applied to the LED lamp, the power supply module of the lamp converts the incoming AC voltage to DC voltage. The power supply unit passes first half cycle of the AC power and the other half of the voltage is blocked by a diode. The power supply unit produces a DC voltage which operates at 30 kHz and the DC voltage is at least 1/15 times the input AC voltage, for example 15V with current of 500 mA. The DC voltage from diode is further rectified by two electrolytic capacitors. The transformer which is AC power is transformed into DC to operate the circuits through the capacitor C1(400v-10 μf) that limits the voltage via 4 schottky diodes B250C1500 that rectify the voltage. The capacity of C1 and its resistance capacity (reactance XC) is explained using following equation.

XC=1/(2πfc)=>ohms and XC=VRMS/I=>ohms
Where, C is C1 capacity and I is the maximum current through the capacitor which is about 350 MA. Also, f is the AC frequency about 50-60 HZ and VRMS is the principle voltage of AC. After the voltage of 20v enters the monolithic diodes of B1 package (B 250C1500- Bridge rectifier); the negative and positive half-cycles are separated. At this point, a negative and positive DC voltage of about 18v is obtained with a very weak current. Then, the voltage enters the Zener diode of D1 so that a fixed voltage of 15v is obtained. Zener diode prevents variance in negative half-cycle and after that the voltage of 15v is purified via C2. Further the additional noise is removed by C3 to have a DC voltage in the circuit.

The power supply unit comprises a resistor R1 and capacitor C1, which in combination limits an incoming alternating current (AC) voltage of 230Volts to 20V. The resistor R1 further restrains an additional AC current at sinusoidal peak. The output 20V of the resistor R1 is given to a bridge rectifier (B250C1500) which is configured to convert an AC input to a direct current (DC) output. All the components in this circuit are sized so that the circuit delivers 15 volt and 30 mA of current at the output to the load. The ripples in the voltage from the rectifier are filtered by capacitor C2 while zener diode prevents variations in negative half cycle of the voltage and regulates the voltage to produce 15 volt. The output voltage remains constant as long as the output current is not more than the input current. The input current is determined by AC voltage input, capacitor C1 and resistor R1. The capacitor C3 further reduces the noise and smoothens the DC output voltage.

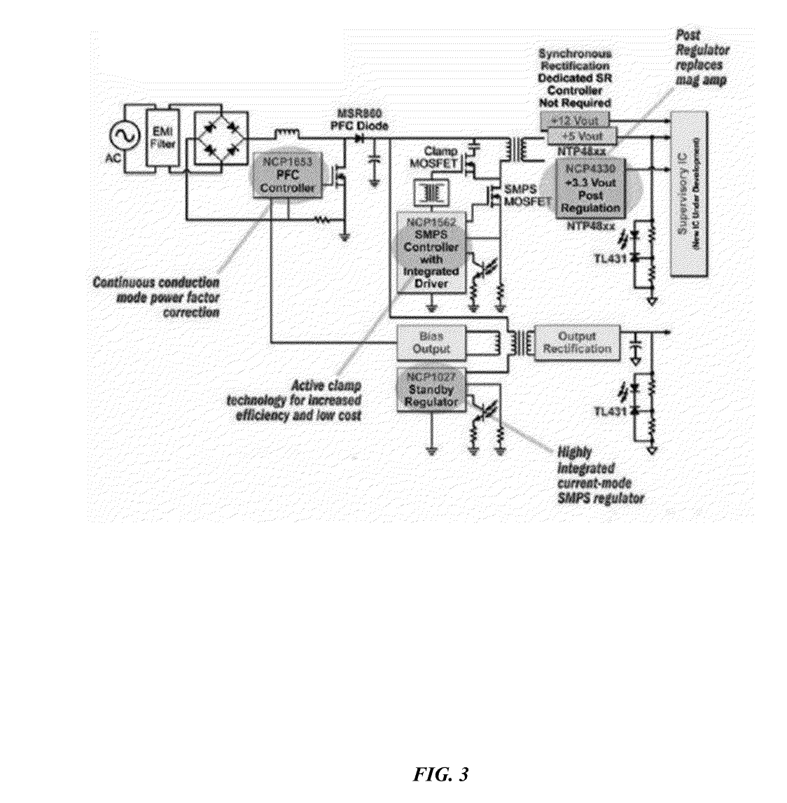

FIG. 3 illustrates a block circuit level diagram for driver module of the LED lamp, according to an embodiment of the present disclosure. The driver module receives 15V of DC voltage from the power supply. The driver module comprises an IC switch mode MAX668 (DC-DC controller), which is configured to support a transformer in driver module. The IC switching mode further comprises a resistor R2 and capacitors C4, C5, which form an R-C web and is configured to control the base frequency of MAX668 IC. The IC MAX668 of the driver module increases the frequency of the input 15VDC to 30 kHz. The output voltage from the capacitor C5 is provided to a single N-channel logic level PWN optimized MOSFET (FDS-6680). The MOSFET transistor is configured to operate in P-CHANNEL, P-FET, N-CHANNEL, and N-FET. The MOSFET is configured to improve the overall efficiency of the DC/DC converter (MAX668) using either synchronous or conventional switching PWM controllers. The IC Pin4 FDS6680 directs the voltage received from the DC/DC controller to the inlet of the transformer with higher current coefficient. Further at output of the MOSFET, a shunt resistor is placed. The shunt resistor is configured to bias with Pin6 to control the switch inside the MAX688 IC. The shunt resistor further controls the over current to MOSFET IC to prevent the IC from burning and also controls the frequency of the oscillator inside MAX688 IC to prevent it from exceeding 30 kHz frequency. A light absorbing diode is placed at the inlet of MOSFET-IC and Pin5 of MAX668 IC to control the IC current with its impedance. The light absorbing diode is an opto-coupler which is configured to change its impedance when exposed to light. The internal impedance of the opto-coupler increases as the light surrounding the LED lamp is more. So, less current will pass through a gate-G of a FET transistor placed at the output of the opto-coupler. Hence the secondary winding of the transformer receives less current through the SMDs. As a result, SMDs do not illuminate maximum light. Similarly, when an ambient light condition or flux surrounding the opto-coupler is more, the impedance of opto-coupler diode is reduced. Consequently, as more current passes through the transistor which increases the current passing in secondary output of transformer. As the current received at SMD boards is increased, the LEDs are lit/lightened at maximum level due to the fact that SMD and LED lightening is changed by the current change (variation in current) and not by voltage change (variation in Voltage). A hysteresis is left in initial and secondary SMD transformers due to a high frequency of 30 KHz. This distortion is removed by an electrolytic capacitor C6 and a Schottky diode. The capacitor C6 configured to omit the distortion due to the high frequency of the circuit. The opto-coupler provides a sufficient voltage and current at the secondary of the transformer. As the current is generated again and driven or passed from the secondary of the transformer, the current has to be unidirectional and the unidirectional current is achieved by a Schottky diode (D2). The voltage becomes direct (DC Voltage) using the diode and the voltage is purified and fixed by two other electrolytic capacitors. The voltage and current at output of the transformer secondary is monitored as they output from D2 and R4, R5 and R6, R7. A feedback is sent to MAX668 IC by using a resistor R5 and a capacitor C7. Depending on the monitored information, the voltage of 15V and the current of 350 mA are used to trigger the SMD assembly and the entire circuit.

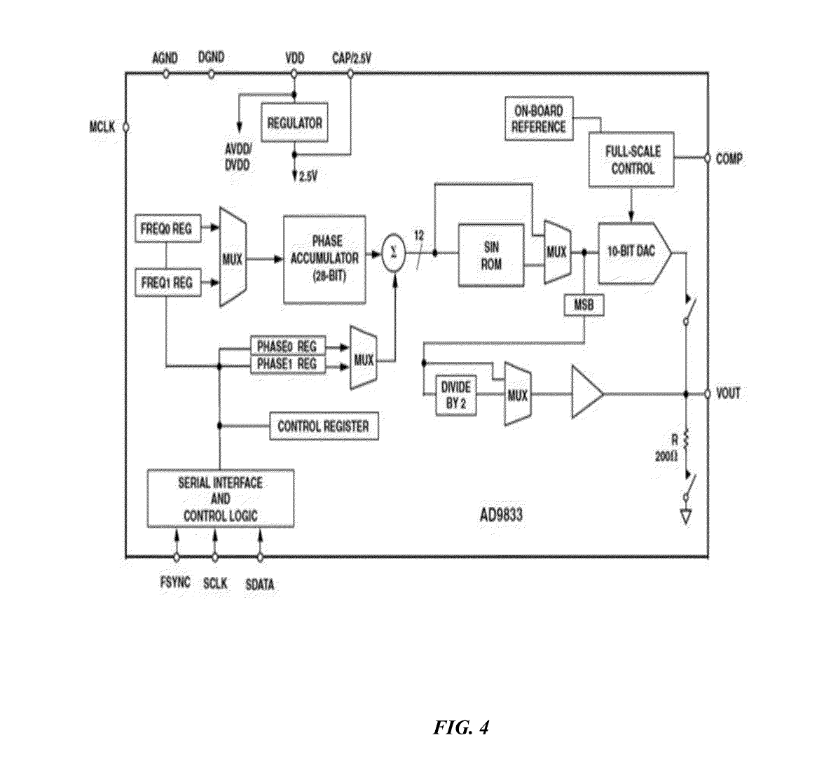

FIG. 4 illustrates a functional block diagram of multi-vibrator adopted in the LED lamp, according to an embodiment herein. The supply voltage to the multi-vibrator IC is supplied by the driver module. The negative voltage is received from Pin 1 and the positive voltage is received from Pin4 and Pin8. The multi-vibrator module comprises a Schmitt Trigger which is designed using a timer IC (IC-555), in order to increase the secured efficiency of Schmitt trigger. Further, by adopting resistors R7(R-C), R8 and capacitor C10, a voltage operating at 100 Hz frequency is produced at the inlet of IC 555 which is of TCL type and is compatible with high frequencies. Moreover, for having an outlet with sufficient current, the two IC inlets are used as short connections. Simultaneously, the output of Pin 3 of the timer 555 IC is provided as input to IC flip flop (TL4013) of TTL type via two resistors of R9 and R10.

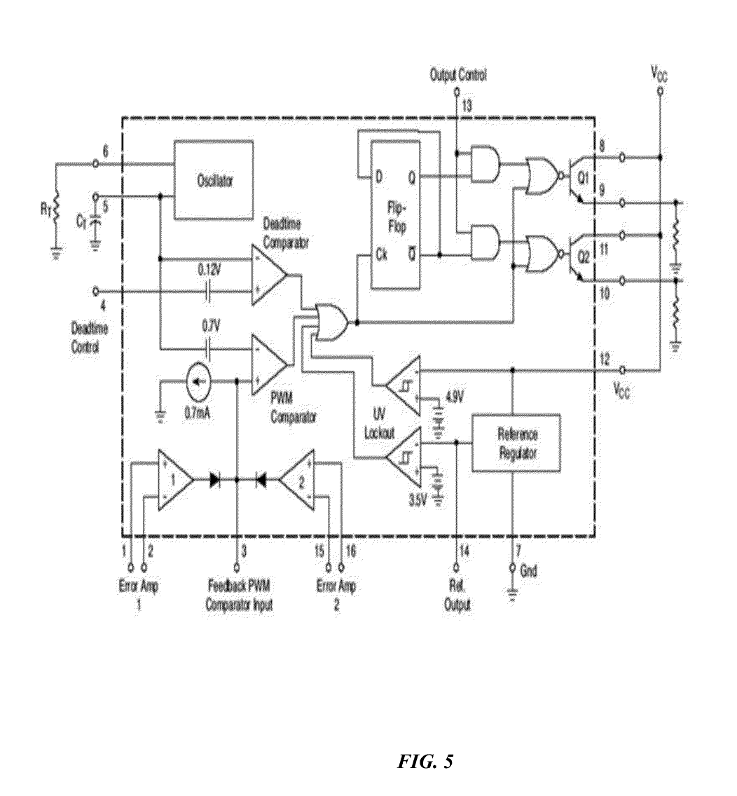

FIG. 5 illustrates a functional block diagram of a flip-flop circuit used in the LED lamp, according to an embodiment herein. The flip-flop IC operates with binary numbers (for example 0 and 1) and the IC output voltage has absolute 50% of duty cycle which is important for Transistor-Transistor Logic. Because of the sensitivity of the multi-vibrator part of the circuit, the input voltage to the IC is rectified, stabilized, distortion free and made constant and distortion less so that the IC does not enter “Lock-up” mode. The lock-up mode interferes with the working of the circuit. The lock-up mode happens or occurs due to AC power fluctuations and the harmonics of the sine wave that enters the circuit with AC phase and neutral connections. The lock-up mode causes the lamp to be turned off after some moments and the lamp is turned on only by pressing the reset button. This is one of the unsolvable problems of AC power and it is more tangible in devices with high frequency. The solution to the above problem is obtained by adding a capacitor C11. An another feedback is provided between an inlet and Q outlet of flip flop IC so as to remove every discrepancy in the working of the flip flop module. On the other hand, 100% separation of signals and 50% activity cycle is established to fix the working of the ICs so that the feedback is vital for SMD process. The negative and positive voltage is applied in the form of square wave to the MOSFET transistors of the flip-flop circuit. The voltage is applied to support MOSFET transistor. The wave enters the inlet of two Schottky diodes of D3 and D4 via two resistors (R11, R12) and is further supplied to the gate of P-FET (T1) and N-FET (T2) transistors. The two diodes are installed in reverse manner (fashion) so that the two transistors never turn on and off simultaneously. The voltage and the current following through the T1 and T2 transistors have a frequency of 100 Hz. When the current has a duration of 10 ms and T1 conducts, T2 does not conduct and vice versa. The output voltage of the transistors current form two different parts, where one part of currents supports the two parallel C14 and C15 capacitors and the other part of the output supports the two parallel C16 and C17 capacitors. The current flowing from C13, C16, C17 and C20 pass through the Shunt resistor to lighten/lit the SMD boards. The Shunt resistors are effective to protect the SMDs from burning. Moreover, two flat capacitors of C12 and C13 are connected in parallel in a part of the circuit to reduce noise and noise discrepancy. The current saving capacitors save the sufficient voltage and current to keep the SMD boards on in 10 ms time in order to have steady light from the light bulb. Because the circuit needs a Coulomb charging capacitor, two capacitors with two separate sources are used and the voltage supplied to these capacitors is at least twice as the voltage of the whole circuit. Finally, sufficient voltage and current are provided to LED SMD board, where a plurality of LEDs is placed in series and parallel. These SMDs light up with maximum light emission due to the wave in the anode and cathode base λ wavelength.

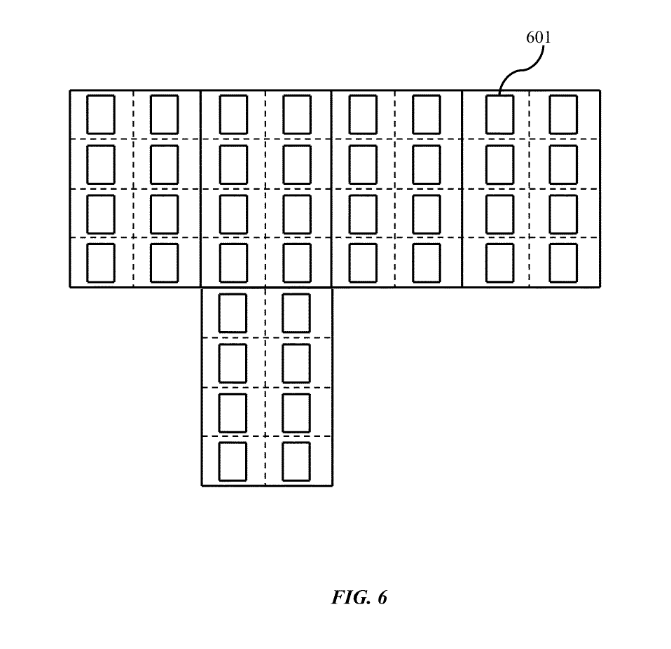

FIG. 6 illustrates a schematic diagram illustrating an arrangement of the LEDs 601 in the SMD assembly, according to an embodiment of the present disclosure. The SMD assembly comprises at least two LED assembly boards (SMD board-1 and SMD board-2). According to the circuit design, the lamp of each part is powered separately at 10 ms intervals. Due to this arrangement, both parts never work simultaneously. The phase difference between SMDs is 180 degrees i.e., when board-1 SMDs are on, board-2 SMDs are off and vice versa. The important aspects of SMD assembly that need to be taken into account are the type of used elements and their biasing that does not allow the SMD boards operate simultaneously. Also, the oppositely placed transistors N-FET (T1) and P-FET (T2) produce regular output current and provide 50% operation of SMDs at the same time. As a result, SMDs switch on and off at a speed of 100 ps. Any difference in luminance is not visible to unarmed eyes, when the SMD boards go on and off at speed of 100 ps. Further a plurality of capacitors is placed in parallel with SMD boards. Due to the capacitors used in SMD boards, the SMDs at switched-off condition are powered at 10 ms intervals even though when the SMDs are not really biased. In a common lamp, there are 5 SMDs of 1 W, but in the disclosed lamp there are at least 10 SMDs of 1 W. This implies that, the lamp illuminates radiant flux with consumption of 10 W with a power consumption of 5 W.

As shown in FIG. 6, LED SMD assembly comprises a set of five boards. Four of the boards are illuminates at 90 degrees inside the light bulb and the other board illuminates at 180 degrees vertical over the other four boards at the lowest part. In another configuration of LED SMD assembly, for 5/5 w lamp, 8 SMD boards are placed at the lower part of four boards. Yet in another combination of the SMD assembly, 12 SMD boards (that is totally 44 SMDs) are placed for ¼ W A22-5050. The number of SMD boards is varied depending on the luminance requirement of the LED lamp.

According to an embodiment herein, the luminance or lumens of the lamp depends on the photon beam angle and radiant flux. When the photon beam angle is more, the radiant flux is relatively less and vice versa. In the LED lamp disclosed in the embodiments herein, depending on the change in beam angle, special setting of SMDs, and also the size of the light bulb are adjusted to achieve the output luminance at its maximum level.

According to an embodiment herein, the need for heat sinks and coolers is eliminated in the LED lamps. Normally, there is a need for heat sink for LED and SMDs having power consumption below 1 W. When ¼ W A22-5050 SMDs are used in the circuit, there is no need for heat sink. On the contrary, when 4 SMDs of ¼ W are considered for the LED lamp, power loss is increased and the circuit gets heated. In such cases the heat sink becomes necessary. But, due to 10 ms switching of two parts of SMDs board and the instantaneous current, only a few seconds are required for the SMDs to reach the power loss level. Nevertheless, at the time of 10 ms, that is at the frequency of 100 Hz of the multi-vibrator SMD board gets switched off for few seconds to decrease the heat generated. As soon as one part of SMD board is on and it is at threshold of warming, the circuit switches the current to the other SMD board. This process prevents SMD boards from heating.

According to an embodiment herein, at the end of the circuit, two electrolytic capacitors are placed parallel to the SMDs and Shunt resistor in-order to save the current in time of high voltage and to keep the SMDs lit up in time of 10 ms blackout. The capacitors also support the ripple, delay the zero crossing and remove the fluctuations of SMD light in the circuit. It is clear that SMDs light changes in harmony with current change not the voltage change.

According to an embodiment herein, the LED lamp comprises a varistor instead of the opto-coupler whose internal resistance changes due to the environment light and the changes are transferred to bias the gate of the transistor by using the voltage to control the current flow between drain and source. When the environment light is not enough, the varistor provides the highest current and when the environment light is sufficient, it provides the lowest current for FET transistors.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A low power consumption Light Emitting Diode (LED) lamp comprises:
a power supply module configured to supply a DC voltage to entire circuit;
a driver module configured to adjust the current level supplied to LEDs depending on a luminance level of a surrounding environment;
a multivibrator and flip-flop module adopted to flash a LED with a period of one second;
a LED Surface Mount Device (SMD) assembly.

2. The LED lamp according to claim 1, wherein the driver module comprises:
a DC-DC controller configured to increases a frequency of an input voltage to a predefined value;
a MOSFET transistor configured to improve an overall efficiency of the DC/DC converter by increasing a current coefficient of the input received;
an opto-coupler comprising a light absorbing diode, and wherein the opto-coupler is configured to change an internal impedance depending on the luminance of surrounding environment.

3. The LED lamp according to claim 2, wherein the opto-coupler adjusts the current flowing to the LED SMD assembly depending on an environment light.

4. The LED lamp according to claim 1, the multivibrator and flip-flop module comprises:
a multi-vibrator circuit configured to generate a square wave signal depending on the voltage received from the driver module, and wherein the square wave generated has 50% duty cycle;
a flip-flop circuit configured to switch the LEDs on/off depending on the square wave signal received from the multi-vibrator.

5. The LED lamp according to claim 4, wherein the flip-flop circuit further comprises:
at least two diodes, and wherein the two diodes are positioned in a reverse manner;
at least two resistors connected in series with the diodes; and
at least two transistors configured to conduct individually for a predetermined interval of time, and wherein one of the two transistors is a P-FET and another of to two transistors is a N-FET.

6. The LED lamp according to claim 4, wherein the square wave signal generated by the multi-vibrator is adopted to operate the two transistors individually by applying a positive voltage of square wave signal to the P-FET transistor and a negative voltage of square wave signal to the N-FET transistor.

7. The LED lamp according to claim 1, wherein the LED SMD board is divided into at least two parts, and wherein the two parts do not work simultaneously.

8. The LED lamp according to claim 1, wherein the two parts of LED SMD board are driven by the voltage received from the transistors of the flip-flop circuit and wherein only one part of the SMD board is switched on at a particular period of time.

9. The LED lamp according to claim 1, wherein the LED SMD assembly is arranged in such a way that a phase difference between the two SMD board parts is 180 degrees.

10. The LED lamp according to claim 1, wherein an output luminance of the LED lamp depends on a change in beam angle, special setting of SMDs, and a size of light bulb.
